(19) United States
(12) Patent Application Publication
(10) Pub. No.: US 2025/0227470 A1
(43) Pub. Date: Jul. 10, 2025

(54) Terminal Authentication Method, Terminal and Network-Side Device

(71) Applicant: VIVO MOBILE COMMUNICATION CO., Ltd., Dongguan (CN)

(72) Inventors: Hongping Zhang, Dongguan (CN); Xiang Pan, Dongguan (CN); Wen Wang, Dongguan (CN)

(21) Appl. No.: 19/091,437

(22) Filed: Mar. 26, 2025

Related U.S. Application Data
(63) Continuation of application No. PCT/CN2023/120290, filed on Sep. 21, 2023.

(30) Foreign Application Priority Data
Sep. 26, 2022 (CN) 202211176984.X

(51) Int. Cl. H04W 12/06; H04L 5/00; H04W 60/00; H04W 64/00; H04W 92/18

(52) U.S. Cl. CPC H04W 12/06; H04L 5/0048; H04W 60/00; H04W 64/00; H04W 92/18

(57) ABSTRACT

A terminal authentication method includes sending, by a first terminal, a first request message to a target network device, where the first request message is used for requesting the target network device to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function.

### CROSS-REFERENCE TO RELATED APPLICATIONS

This application is a Bypass Continuation Application of International Patent Application No. PCT/CN2023/120290 filed Sep. 21, 2023, and claims priority to Chinese Patent Application No. 202211176984.X filed Sep. 26, 2022, the disclosures of which are hereby incorporated by reference in their entireties.

### BACKGROUND OF THE INVENTION

### Field of the Invention

This application belongs to the technical field of communications, and in particular, relates to a terminal authentication method, a terminal and a network-side device.

### Description of Related Art

Sidelink (SL) communication refers to direct communication between user equipment (UE). Sidelink is also known as secondary link, side link, or bylink. At present, in addition to positioning based on a reference signal of a Uu port (wireless interface between UE and a base station), there is also a need for positioning based on a PC5 port (wireless interface between UE and UE) in scenarios such as vehicle to everything (V2X). For example, when a vehicle is not within a coverage area of a mobile network, sidelink positioning may be required.

### SUMMARY OF THE INVENTION

According to a first aspect, an embodiment of this application provides a terminal authentication method, including:
sending, by a first terminal, a first request message to a target network device, where the first request message is used for requesting the target network device to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function.

According to a second aspect, an embodiment of this application provides a terminal authentication method, including:
receiving, by an access and mobility management function AMF, a first request message from a first terminal, where the first request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; and
determining, by the AMF, whether the first terminal has the authority of the first-type terminal based on the first request message.

According to a third aspect, an embodiment of this application provides a terminal authentication method, including:
receiving, by a location management function LMF, a first request message from a first terminal or a second request message from an access and mobility management function AMF, where the first request message or the second request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; and
in a case that the LMF receives the first request message from the first terminal, determining, by the LMF, whether the first terminal has the authority of the first-type terminal based on the first request message; or
in a case that the LMF receives the second request message from the AMF, regarding, by the LMF, the first terminal as the first-type terminal, and saving first information of the first terminal.

According to a fourth aspect, an embodiment of this application provides a terminal authentication method, including:
receiving, by a second terminal, a first message from a first terminal, where the first message includes first information and a signature of the first terminal, and the first information is used for determining that the first terminal is a first-type terminal; the first-type terminal includes an anchor UE or a location server UE, the anchor UE is a terminal whose location is known and which participates in sending or measuring a sidelink positioning reference signal, and the location server UE is a terminal which provides a sidelink positioning service function; and
determining, by the second terminal, whether the first terminal has the authority of the first-type terminal based on the first message.

According to a fifth aspect, an embodiment of this application provides a terminal authentication apparatus, including:
a sending module configured to send a first request message to a target network device, where the first request message is used for requesting the target network device to register a first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function.

According to a sixth aspect, an embodiment of this application provides a terminal authentication apparatus, including:
a receiving module configured to receive a first request message from a first terminal, where the first request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; and
a processing module configured to determine whether the first terminal has the authority of the first-type terminal based on the first request message.

According to a seventh aspect, an embodiment of this application provides a terminal authentication apparatus, including:
a receiving module configured to receive a first request message from a first terminal or a second request message from an access and mobility management function AMF, where the first request message or the second request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; and
a processing module configured to, in a case that the first request message from the first terminal is received, determine whether the first terminal has the authority of the first-type terminal based on the first request message; or
in a case that the second request message from the AMF is received, regard the first terminal as the first-type terminal, and save first information of the first terminal.

According to an eighth aspect, an embodiment of this application provides a terminal authentication apparatus, including:
a receiving module configured to receive a first message from a first terminal, where the first message includes first information and a signature of the first terminal, and the first information is used for determining that the first terminal is a first-type terminal; the first-type terminal includes an anchor UE or a location server UE, the anchor UE is a terminal whose location is known and which participates in sending or measuring a sidelink positioning reference signal, and the location server UE is a terminal which provides a sidelink positioning service function; and
a processing module configured to determine whether the first terminal has the authority of the first-type terminal based on the first message.

According to a ninth aspect, an embodiment of this application provides a first terminal, including a processor and a memory, where the memory stores a program or an instruction executable on the processor, and when the program or the instruction is executed by the processor, the steps of the method according to the first aspect are implemented.

According to a tenth aspect, an embodiment of this application provides a first terminal, including a processor and a communication interface, where the communication interface is configured to send a first request message to a target network device, the first request message is used for requesting the target network device to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function.

According to an eleventh aspect, an embodiment of this application provides a network-side device, including a processor and a memory, where the memory storages a program or an instruction executable on the processor, and when the program or the instruction is executed by the processor, the steps of the method according to the second aspect are implemented.

According to a twelfth aspect, an embodiment of this application provides a network-side device, including a processor and a communication interface, where the communication interface is configured to receive a first request message from a first terminal, the first request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; the processor is configured to determine whether the first terminal has the authority of the first-type terminal based on the first request message.

According to a thirteenth aspect, an embodiment of this application provides a network-side device, including a processor and a memory, where the memory stores a program or an instruction executable on the processor, and when the program or the instruction is executed by the processor, the steps of the method according to the third aspect are implemented.

According to a fourteenth aspect, an embodiment of this application provides a network-side device, including a processor and a communication interface, where the communication interface is configured to receive a first request message from a first terminal or a second request message from an access and mobility management function AMF, the first request message or the second request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; the processor is configured to, in a case that the network-side device receives the first request message from the first terminal, determine, by the network-side device, whether the first terminal has the authority of the first-type terminal based on the first request message; or in a case that the network-side device receives the second request message from the AMF, regard, by the network-side device, the first terminal as the first-type terminal, and save first information of the first terminal.

According to a fifteenth aspect, an embodiment of this application provides a second terminal, including a processor and a memory, where the memory stores a program or an instruction executable on the processor, and when the program or instruction is executed by the processor, the steps of the method according to the third aspect are implemented.

According to a sixteenth aspect, an embodiment of this application provides a second terminal, including a processor and a communication interface, where the communication interface is configured to receive a first message from a first terminal, the first message includes first information and a signature of the first terminal, the first information is used for determining that the first terminal is a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; the processor is configured to determine whether the first terminal has the authority of the first-type terminal based on the first message.

According to a seventeenth aspect, an embodiment of this application provides a communication system, including a first terminal, a second terminal, and a network-side device, where the first terminal may be configured to implement the steps of the terminal authentication method according to the first aspect, the second terminal may be configured to implement the steps of the terminal authentication method according to the third aspect, and the network-side device may be configured to implement the steps of the terminal authentication method according to the second aspect or the third aspect.

According to an eighteenth aspect, an embodiment of this application provides a non-transitory readable storage medium storing a program or an instruction, where when the program or the instruction is executed by a processor, the steps of the method according to the first aspect are implemented, or the steps of the method according to the second aspect are implemented, or the method according to the third aspect are implemented, or the steps of the method according to the fourth aspect are implemented.

According to a nineteenth aspect, an embodiment of this application provides a chip including a processor and a communication interface coupled to the processor, where the processor is configured to run a program or an instruction to implement the method according to the first aspect, or the method according to the second aspect, or the method according to the third aspect, or the method according to the fourth aspect.

According to a twentieth aspect, an embodiment of this application provides a computer program/program product stored in a non-transitory storage medium, where the computer program/program product is executed by at least one processor to implement the steps of the terminal authentication method according to the first aspect, the second aspect, the third aspect, or the fourth aspect.

### BRIEF DESCRIPTION OF THE DRAWINGS

FIG. 1 is a structural diagram of a wireless communication system applicable in an embodiment of this application;

FIG. 2 is a schematic diagram of a system architecture for a terminal authentication method according to an embodiment of this application;

FIG. 3 is a schematic diagram of a protocol for a terminal authentication method according to an embodiment of this application;

FIG. 4 is a first schematic flowchart of a terminal authentication method according to an embodiment of this application;

FIG. 5 is a first schematic interaction flowchart of a terminal authentication method according to an embodiment of this application;

FIG. 6 is a second schematic interaction flowchart of a terminal authentication method according to an embodiment of this application;

FIG. 7 is a third schematic interaction flowchart of a terminal authentication method according to an embodiment of this application;

FIG. 8 is a fourth schematic interaction flowchart of a terminal authentication method according to an embodiment of this application;

FIG. 9 is a fifth schematic interaction flowchart of a terminal authentication method according to an embodiment of this application;

FIG. 10 is a second schematic flowchart of a terminal authentication method according to an embodiment of this application;

FIG. 11 is a third schematic flowchart of a terminal authentication method according to an embodiment of this application;

FIG. 12 is a fourth schematic flowchart of a terminal authentication method according to an embodiment of this application;

FIG. 13 is a first schematic structural diagram of a terminal authentication apparatus according to an embodiment of this application;

FIG. 14 is a second schematic structural diagram of a terminal authentication apparatus according to an embodiment of this application;

FIG. 15 is a third schematic structural diagram of a terminal authentication apparatus according to an embodiment of this application;

FIG. 16 is a fourth schematic structural diagram of a terminal authentication apparatus according to an embodiment of this application;

FIG. 17 is a schematic structural diagram of a communication device according to an embodiment of this application.

FIG. 18 is a schematic structural diagram of a terminal according to an embodiment of this application; and

FIG. 19 is a schematic structural diagram of a network-side device according to an embodiment of this application.

### DESCRIPTION OF THE INVENTION

The technical solutions in embodiments of this application will be clearly described below with reference to the accompanying drawings in the embodiments of this application. Apparently, the described embodiments are merely some rather than all of the embodiments of this application. All other embodiments obtained by those of ordinary skill in the art based on the embodiments of this application fall within the scope of protection this application.

Terms such as “first” and “second” in the description and claims of this application are used for distinguishing similar objects, instead of describing a specific order or sequence. It is to be understood that terms used in this way are exchangeable where appropriate, so that the embodiments of this application can be implemented in an order different from the order shown or described herein; and the objects distinguished by “first” and “second” are usually of the same class and the number of the objects is not limited; for example, the number of first objects may be one or more. In addition, “and/or” in the description and claims represents at least one of the connected objects. Character “/” generally represents an “or” relationship between the associated objects.

It is worth pointing out that the technologies described in the embodiments of this application are not limited to the long term evolution (LTE)/LTE-advanced (LTE-A) system, and may further be applied to other wireless communication systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” in the embodiments of this application are often used interchangeably. The technologies described not only can be applied to the systems and radio technologies mentioned above, but also can be applied to other systems and radio technologies. The following description describes the new radio (NR) system for example purposes and uses NR terminology in most of the following description, but these technologies can also be applied to applications outside of NR system applications, such as 6^{th} generation (6G) communication systems.

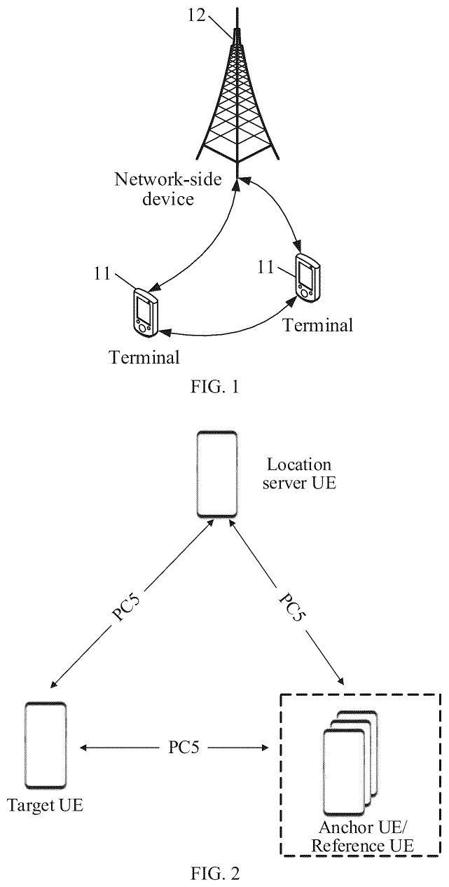

FIG. 1 is a block diagram of a wireless communication system applicable in an embodiment of this application. The wireless communication system includes a terminal 11 and a network-side device 12. The terminal 11 may be a terminal-side device such as a mobile phone, a tablet personal computer, a laptop computer or a notebook computer, a personal digital assistant (PDA), a hand-held computer, a netbook, an ultra-mobile personal computer (UMPC). a mobile Internet device (MID), an augmented reality (AR)/virtual reality (VR) device, a robot, a wearable device, vehicle user equipment (VUE), pedestrian user equipment (PUE), smart home (home devices with wireless communication functions, such as refrigerators, televisions, washing machines, or furniture), a game console, a personal computer (PC), an ATM or a self-service machine. The wearable device includes a smart watch, a smart hand ring, a smart headphone, smart glasses, a smart jewelry (smart bracelet, smart chain bracelet, smart ring, smart necklace, smart anklet, smart chain anklet, etc.), a smart wristband, smart clothing, etc. It is to be understood that the type of the terminal 11 is not limited in embodiments of this application. The network-side device 12 may include an access network device or a core network device. The access network device 12 may also be referred to as a wireless access network device, a radio access network (RAN), a wireless access network function, or a wireless access network unit. The access network device 12 may include a base station, a WLAN access point, a WiFi node, or the like. The base station may be referred to as a node B, an evolved node B, an access point, a base transceiver station (BTS), a radio base station, a radio transceiver, a basic service set (BSS), an extended service set (ESS), a home node B, a home evolved node B, a transmitting receiving point (TRP), or some other suitable term in the art, as long as the same technical effect is achieved. The base station is not limited to specific technical vocabulary. It is to be understood that in embodiment of this application, only the base station in the NR system is used as an example, but the type of the base station is not limited. The core network device may include, but is not limited to, at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), unified data repository (UDR), a home subscriber server (HSS) centralized network configuration (CNC), a network repository function (NRF), a network exposure function (NEF), local NEF (L-NEF), a binding support function (BSF), an application function (AF), etc. It is to be understood that the embodiments of this application are introduced only by taking a core network device in an NR system as an example, and the type of the core network device is not limited.

First, relevant contents involved in the embodiments of this application are introduced.

A long term evolution (LTE) system supports a sidelink (SL), which may also be referred to as a secondary link or a side link, and is used for direct data transmission between terminals without using a network device.

The design of LTE SL is suitable for specific public safety affairs (such as emergency communication in fire or earthquake disaster areas), or vehicle to everything (V2X) communication. Vehicle to everything communication includes various services, such as basic security communication, advanced (autonomous) driving, fleet formation, sensor extension, and so on. Since LTE SL only supports broadcast communication, it is mainly used for basic security communication. Other advanced V2X services with strict quality of service (QOS) requirements in terms of latency and reliability will be supported through new radio (NR) SL.

A 5G NR system may also support SL interfaces for direct communication between terminals, and supports three transmission methods: broadcast, groupcast, and unicast.

At present, in addition to positioning based on a reference signal of a Uu port (wireless interface between UE and a base station), there is also a need for positioning based on a PC5 port (wireless interface between UE and UE) in scenarios such as V2X. For example, when a vehicle is not within a coverage area of a mobile network, SL positioning may be required.

According to the current standard discussion, 3GPP needs to introduce SL positioning based on the PC5 port in R18, that is, positioning by measuring an SL PRS of the PC5 port. During sidelink positioning, other UE may be used for auxiliary positioning, but it cannot guarantee that the UE participating in positioning is trustworthy. Therefore, how to determine whether the UE participating in positioning is trustworthy is a technical problem that needs to be solved.

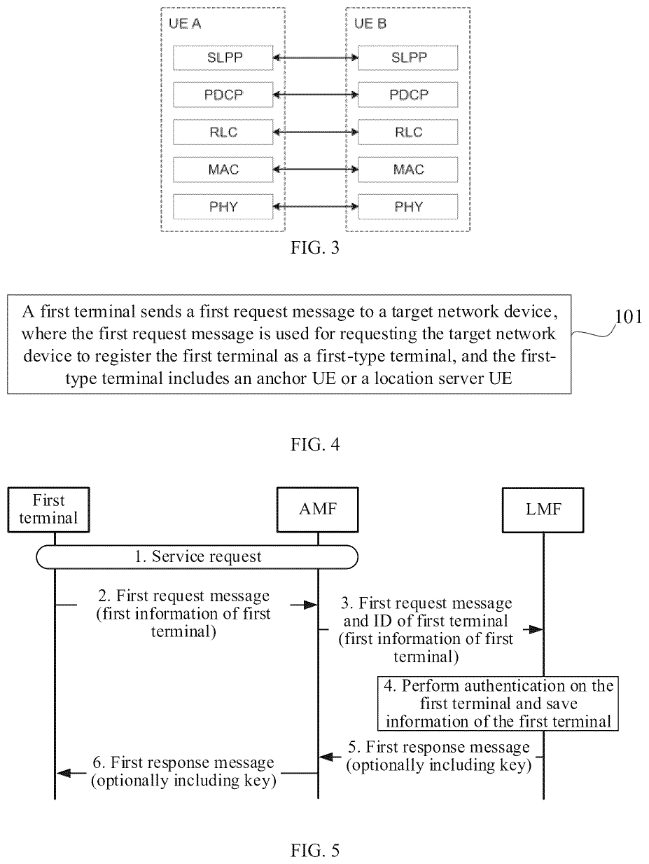

FIG. 2 illustrates an architecture of SL positioning. In the architecture,
a location server UE is a terminal that provides a location service function, and the Location Server UE may be considered a mandatory role in an SL positioning process. Location Server UE receives an SL positioning request carrying quality of service QoS for location services or triggers its own SL positioning requirements, and then determines a positioning method, positioning configuration information, and which terminals participate as anchor UE in SL positioning based on the positioning QoS. In an SL positioning process, Location Server UE may be a standalone role (terminal) or may also serve as a target UE (in this case, Location Server UE positions itself. Certainly, it may also be said that the target UE has the role of Location Server UE) or the anchor UE (for example, Location Server UE assisting in the sending or measurement of the SL PRS) or a reference UE. In an SL positioning process, a terminal (UE) may act as Location Server UE, while in another SL positioning process, this terminal may not act as Location Server UE, for example, only as anchor UE only.

It is to be understood that the positioning service function includes one or any combination of the following: determining a positioning method based on positioning QoS, determining positioning configuration information, and determining an anchor UE participating in positioning.

It is to be understood that Location Server UE plays a role in controlling the execution of SL positioning in a positioning process, and may also be referred to by other names, such as controlling terminal, which is not limited here.

Target UE is a target UE of positioning, and the positioning requires acquiring the absolute location, relative location, or ranging of the terminal.

Anchor UE is a terminal that provides positioning assistance, such as sending or measuring the SL PRS. For absolute positioning, anchor UE is a terminal whose location is known or can be known. The number of anchor UEs may be one or more, or there may be no separate anchor UE. For example, Location Server UE also serves as anchor UE. Anchor UE may also be referred to as a located terminal or an auxiliary terminal. Usually, a roadside unit (RSU) may serve as anchor UE.

Reference UE is a location reference UE used for relative positioning or ranging positioning. Reference UE may be a standalone terminal, one of anchor UE, or Location Server UE.

It is to be understood that since Location Server UE may also serve as anchor UE, in the above architecture, in some scenarios, there may no separate anchor UE and/or separate reference UE. In addition, Location Server UE may be the same terminal as the target UE or a different terminal.

For SL positioning, a new protocol layer may be introduced. This protocol layer is used for Location Server UE to exchange positioning messages with a target UE and anchor UE. For example, a sidelink positioning protocol (SLPP) layer in FIG. 3 is a newly introduced protocol layer for SL positioning, located at a layer above a packet data convergence protocol (PDCP) layer (an SL positioning protocol stack in FIG. 3 is only an example, it is not limited in this embodiment of this application, and for example, SLPP may also be located at a layer above PC5 radio resource control (RRC) or PC5-S).

It is to be understood that a long term evolution positioning protocol (LPP) may also be reused instead of introducing a new protocol layer. At present, the LPP protocol is adopted between the location server and the terminal in positioning based on the Uu interface. For ease of description, description will be made subsequently by taking the SLPP protocol as an example.

In the above positioning architecture, firstly, Location Server UE receives a positioning request carrying positioning QoS and a target UE ID, or Location Server UE triggers itself to position target UE or itself (i.e., Location Server UE is also target UE). Then, Location Server UE identifies/determines anchor UE participating in the positioning and determines a positioning method based on the positioning QoS and other information. Next, Location Server UE uses the SL positioning protocol (such as SLPP protocol in the above figure) to perform SL positioning and obtain an SL positioning result. It interacts SL positioning protocol messages with target UE and anchor UE, including, for example, providing positioning assistance information (configuring measurement of an SL positioning reference signal (PRS)), requesting location information, receiving SL positioning measurement, etc.

Terminal authentication methods provided in embodiments of this application will be described below in detail through some embodiments and application scenarios with reference to the accompanying drawings.

FIG. 4 is a first schematic flowchart of a terminal authentication method according to an embodiment of this application. Referring to FIG. 4, the method provided in this embodiment includes the following step:

In step 101, a first terminal sends a first request message to a target network device. The first request message is used for requesting the target network device to register the first terminal as a first-type terminal. The first-type terminal includes an anchor UE or a location server UE. The anchor UE is a terminal whose location is known and which participates in sending or measuring a sidelink positioning reference signal. The location server UE is a terminal which provides a sidelink positioning service function.

For example, the first request message may be a registration request message used for requesting the target network device to register a first-type terminal, that is, to register the first terminal. The target network device needs to perform authentication on the first terminal to determine whether the first terminal has the authority of the first-type terminal, that is, whether it may be used as the first-type terminal. After determining that the first terminal is the first-type terminal, the target network device registers the first terminal. The first-type terminal includes an anchor UE or a location server UE. The anchor UE may be a terminal whose location is known and which participates in sending or measuring a sidelink positioning reference signal. The location server UE is a terminal which provides a sidelink positioning service function.

In the method in this embodiment, the first terminal sends a first request message to the target network device. The first request message is used for requesting the target network device to register the first terminal as a first-type terminal. The first-type terminal includes an anchor UE or a location server UE. After the target network device performs authentication on the first terminal, the first terminal being used for subsequently participating in an SL process can ensure the trustworthiness of the first terminal, prevent a non-authenticated terminal from impersonating the first-type terminal, and improve the security of SL positioning.

Optionally, the method further includes the following step:

The first terminal receives a first response message sent by the target network device. The first response message is a response message corresponding to the first request message.

Optionally, the target network device is an access and mobility management function AMF. The first request message is a non-access stratum NAS message. Or the target network device is a location management function LMF The first request message is a location service (LCS) message or a long term evolution positioning protocol LPP message.

For example, the AMF may perform authentication on the first-type terminal, and the LMF may also perform authentication on the first-type terminal.

In a case that the LMF performs authentication, if the first terminal has the authority of the first-type terminal, the LMF sends a response message corresponding to the first request message (referred to as a first response message here, the message name is not limited) to the first terminal. The first response message may be an LCS message or an LPP message.

In a case that the AMF performs authentication, if the first terminal has the authority of the first-type terminal, the AMF sends a second request message to the LMF, and the second request message carries information of the first terminal. The LMF may save the information of the first terminal for possible subsequent SL positioning. The LMF sends the second response message corresponding to the second request message to the AMF.

Optionally, the AMF sends a first response message to the first terminal. In a case that the AMF performs authentication, the first request message may be a registration request message of an NAS, and the first response message may be a registration accept message (Registration Accept) of the NAS. In a case that the LMF performs authentication, the first response message may be carried through a container in NAS signaling, such as through a downlink NAS transport message (DL NAS TRANSPORT message, which is an NAS message), the message includes a container, and the container corresponds to the first response message above.

Optionally, in a case that the target network device is the LMF, step 101 may be implemented in the following way:

The first terminal sends the first request message to the target network device through the AMF. The first request message is carried through a container in NAS signaling.

Optionally, the first terminal sends an uplink NAS transport message of the NAS to the AMF, the uplink NAS transport message includes a container, and the container corresponds to the first request message.

For example, the first terminal sends a first request message to the AMF, the AMF forwards it to the LMF The first request message may be carried through a container in NAS signaling, such as through a container in the uplink NAS transport message (UL NAS TRANSPORT, which is an NAS message).

Optionally, in a case that the target network device is the AMF, the first request message is an NAS registration request message.

Optionally, the first request message includes at least one of:
location information of the first terminal, a sidelink SL identifier ID of the first terminal, an indicator of having the capacity of the first-type terminal, an SL positioning capacity of the first terminal, or transport configuration information of the SL positioning reference signal PRS.

For example, the location information may be, for example, latitude and longitude information; the SL identifier ID may be, for example, an SL layer layer2 ID or application layer Application Layer UE ID; the SL positioning capacity of the first terminal may include, for example, whether it supports sending an SL-PRS, whether it supports measuring an SL-PRS, supported SL positioning methods, etc.

For example, the first terminal is anchor UE, the SL PRS transport configuration information of the anchor UE (if it is anchor UE, it can determine the SL PRS transport configuration by itself), that is, the anchor UE sends the SL PRS on a resource indicated by the transport configuration information.

Exemplarily, referring to FIG. 5, in the solution shown in FIG. 5, the LMF performs authentication on the first terminal. The method includes the following steps:

In step 1, the terminal sends a service request to the AMF.

For example, if the terminal is in an idle state (CM-IDLE), the terminal initiates a service request and enters a connected state (CM-CONNECTED). Connection management CM describes the signaling connection state between the terminal and a 5G core network node (AMF).

In steps 2 to 3, the first terminal sends a first request message to the LMF.

For example, the first request message is used for requesting the LMF to register as a first-type terminal.

Optionally, the first request message may include first information of the first terminal. The first information of the first terminal includes one or more of the following:
location information of the first terminal, a sidelink SL identifier ID of the first terminal, an indicator of having the capacity of the first-type terminal, an SL positioning capacity of the first terminal, or transport configuration information of the SL positioning reference signal PRS.

The operation that the first terminal sends a first request message to the LMF may include the following steps:

In step 2, the first terminal sends an NAS message (such as UL NAS TRANSPORT message) to the AMF. The message includes a container, and the container corresponds to the first request message.

In step 3, the AMF submits the first request message in the NAS message to the LMF. Optionally, in addition to the first request message, the AMF may also submit the ID of the terminal to the LMF. The ID of the terminal may be a permanent equipment identifier (PEI) or a subscription permanent identifier (SUPI). It is to be understood that the ID of the terminal here is determined by the AMF, instead of the terminal, and is included in the first registration request message, thus ensuring the trustworthiness of the ID of the terminal.

In step 4, the LMF performs authentication on the first terminal and saves the first information of the first terminal.

For example, the LMF performs authentication on the first terminal. For example, the LMF pre-configures IDs of terminals that can be used as the first-type terminal. If the received ID of the terminal is in this pre-configured list, the authentication passes; alternatively, the information about whether it is the first-type terminal or whether it has the authority of being used as the first-type terminal may be part of subscription information and stored in unified data management (UDM), and the LMF acquires from UDM whether the first terminal UE has the authority of being used as the first-type terminal.

After the authentication succeeds, the LMF saves the first information of the first terminal for possible subsequent SL positioning.

In steps 5 to 6, the LMF sends a response message corresponding to the first request message to the first terminal.

For example, the operation that the LMF sends a response message corresponding to the first request message to the first terminal may include the following steps:

In step 5, the LMF submits the first response message to the AMF.

In step 6, the AMF sends an NAS message (such as DL NAS TRANSPORT message) to the first terminal. The message includes a container, and the container corresponds to the first response message.

Optionally, the first response message includes a key, and the key may be a private key of an asymmetric key.

In this embodiment, after acquiring authenticated first-type terminals, the LMF uses these first-type terminals to subsequently participate in the SL process, thus preventing a non-authenticated terminal from impersonating the first-type terminal and improving the security of SL positioning.

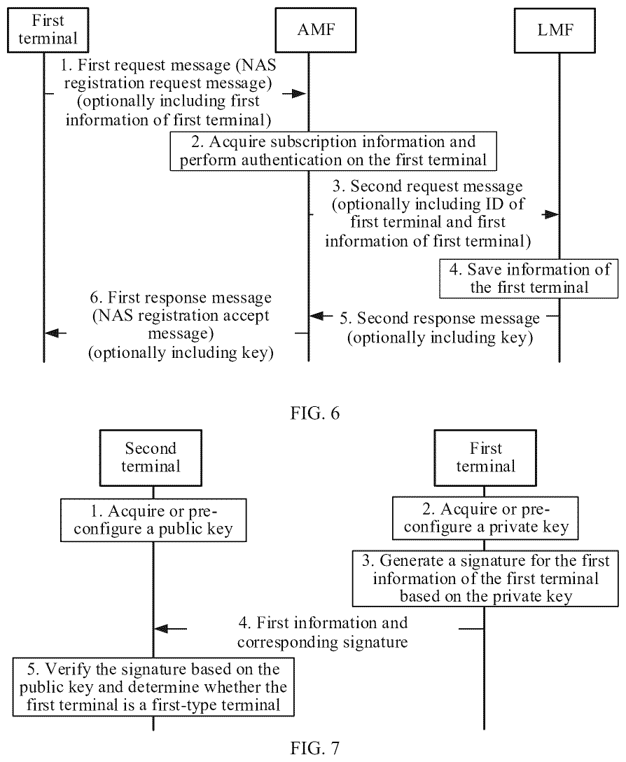

Exemplarily, referring to FIG. 6, in the solution shown in FIG. 6, the AMF performs authentication on the first terminal, and the method includes the following steps:

In step 1, a first terminal sends a first request message to an AMF. The first request message is used for registering the first-type terminal to the AMF. The first request message may be a registration request message from of an NAS.

For example, when the first terminal is turned on, it needs to register to the network-side device, and the first terminal sends an NAS message (such as a registration request message) to the AMF.

In some embodiments, the registration request message includes first information of the first terminal. Please refer to the above embodiment.

In step 2, the AMF acquires subscription information and performs authentication on the first terminal.

The information about whether it is a first-type terminal or whether it has the authority to being used the first-type terminal may be part of the subscription information and stored in a UDM. The AMF acquires the subscription information of UE from the UDM and performs authentication on the first terminal. Based on this, whether the first terminal has the authority of the first-type UE is determined. The subscription information may further include location information of the terminal.

In step 3, in a case that the first terminal has the authority of the first-type terminal, the AMF sends a second request message to an LMF. The second request message is used for requesting to register the first terminal as a first-type terminal.

Optionally, the second request message may include ID of the first terminal and/or first information of the first terminal.

In step 4, the LMF saves the first information of the first terminal for possible subsequent SL positioning.

In step 5, the LMF submits a second response message to the AMF.

In some embodiments, the second response message includes a key, and the key may be a private key of an asymmetric key.

In step 6, the AMF sends a first response message to the first terminal. The first response message may be an NAS message-registration accept message.

Optionally, the registration accept message includes a key, and the key may be a private key of an asymmetric key. The key may be a key sent by the LMF or a key determined by the AMF.

In this embodiment, the AMF performs authentication on the first-type UE and sends relevant information of the first terminal to the LMF after authentication; after acquiring authenticated first-type terminals, the LMF uses these first-type terminals to subsequently participate in the SL process, thus preventing a non-authenticated terminal from impersonating the first-type terminal and improving the security of SL positioning.

Optionally, referring to FIG. 7, the method further includes the following steps:
the first terminal generates a signature based on the key and first information of the first terminal; and
the first terminal sends a first message to a second terminal, where the first message includes the first information and the signature, and the first information is used for determining that the first terminal is the first-type terminal.

For example, the first-type terminal is pre-configured with the private key of the asymmetric key, or acquires the private key of the asymmetric key from the network-side device (refer to the embodiments shown in FIG. 5 and FIG. 6). The first terminal uses this private key to generate a signature on the first information. The first information includes, for example, information indicating whether it is a first-type terminal, configuration information of the first-type terminal (such as SL PRS transport configuration), etc. The first terminal sends the first information and signature, and the second terminal receiving the first information verifies the signature based on a public key to determine whether the first terminal is a first-type terminal. For example, the second terminal generates a new signature based on the public key in response to the received first information, matches the received signature with the new signature. If matching succeeds, it indicates that the authentication succeeds and the first terminal is a first-type terminal.

The second terminal may be pre-configured with the public key of the asymmetric key, or acquires the public key of the asymmetric key from the network-side device.

The above public and the private keys are a pair of paired keys.

The step of acquiring the public key or private key of the asymmetric keys from the network-side device may be a step of receiving the public key or private key sent by the AMF or the access network device.

The second terminal may be a target UE of SL positioning or a third-party terminal (for example, this terminal verifies a location server UE), or it may be a location server UE for SL positioning (for example, this location server UE verifies anchor UE).

In this embodiment, the first-type terminal uses the private key to generate a signature on the first information, the first information includes information of the first-type terminal, and the information of the first-type terminal may be used for indicating that the terminal is a first-type terminal, that is to say, the second terminal that receives the information may consider the first terminal to be a first-type terminal after the signature is successfully verified, thus improving the security of SL positioning.

Optionally, the step of the first terminal sending a first message to a second terminal includes the following steps:
the first terminal sends the first message to the second terminal through a sidelink unicast connection between the first terminal and the second terminal; or,
the first terminal broadcasts and sends the first message; or
the first terminal sends the first message to the second terminal after receiving a discovery solicitation message broadcasted by the second terminal, where the first message is a discovery response message.

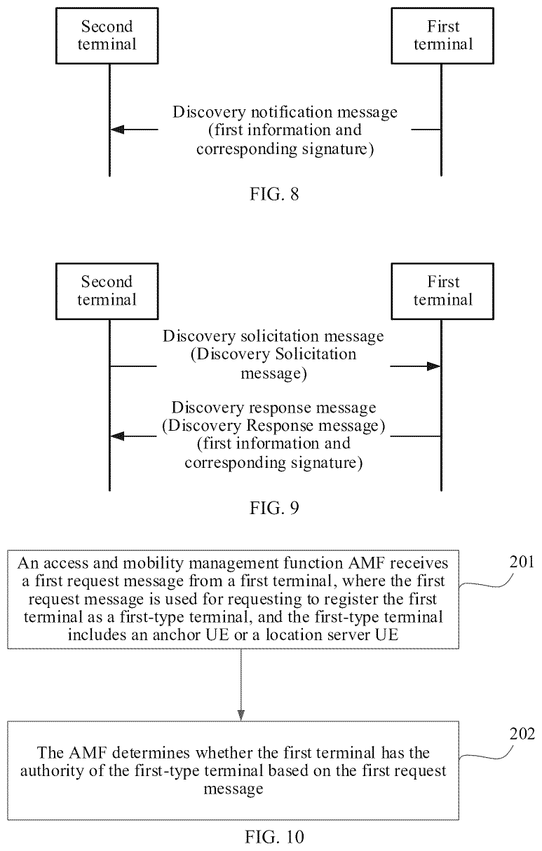

For example, the first terminal sends the first information and corresponding signature, which may be sent through an established SL unicast connection as shown in FIG. 8, or, may be sent through broadcasting as shown in FIG. 9, for example, through a mode A or mode B of a discovery process.

It is to be understood that the method shown in FIG. 7 may be implemented together with FIG. 4, FIG. 5, and FIG. 6, or may be separately implemented as an embodiment.

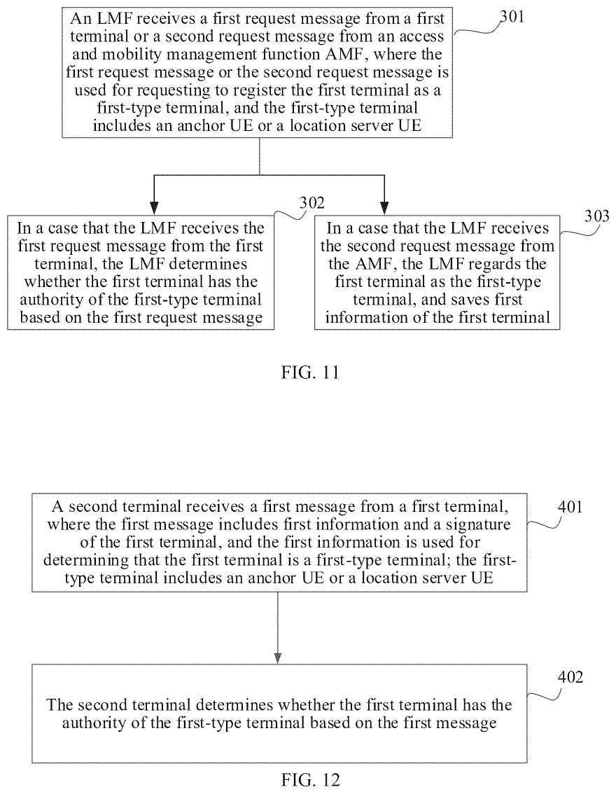

FIG. 10 is a second schematic flowchart of a terminal authentication method according to an embodiment of this application. Referring to FIG. 10, the method provided in this embodiment includes the following steps:

In step 201, an access and mobility management function AMF receives a first request message from a first terminal, where the first request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function.

In step 202, the AMF determines whether the first terminal has the authority of the first-type terminal based on the first request message.

Optionally, the step that the AMF determines whether the first terminal has the authority of the first-type terminal based on the first request message includes the following steps:
the AMF acquires subscription information of the first terminal; and
the AMF determines whether the first terminal has the authority of the first-type terminal based on the subscription information of the first terminal and information of the first terminal included in the first request message.

Optionally, the first request message includes at least one of:
location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the first request message is a non-access stratum NAS registration request message.

Optionally, the method further includes the following step:
the AMF sends a first response message to the first terminal.

Optionally, the first response message includes a key.

Optionally, the key is a private key of an asymmetric key.

Optionally, the key is used for generating a signature by the first terminal.

Optionally, the method further includes the following steps:
in a case that the AMF determines that the first terminal has the authority of the first-type terminal, a second request message is sent to a location management function LMF, where the second request message is used for requesting to register the first terminal as a first-type terminal; and
the AMF receives the second response message from the LMF.

The registration requested by the second request message does not require authentication by the LMF, and only the relevant information needs to be saved.

Optionally, the second request message includes at least one of: an identifier ID of the first terminal, location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the second response message includes a key.

Optionally, the key is a private key of an asymmetric key.

Optionally, the key is used for generating a signature by the first terminal.

The implementation process and technical effects of the method in this embodiment are similar to those in the method embodiment on the first terminal side. For details, please refer to the detailed introduction in the method embodiment on the first terminal side, which will not be repeated here.

FIG. 11 is a third schematic flowchart of a terminal authentication method according to an embodiment of this application. Referring to FIG. 11, the method provided in this embodiment includes the following steps:
in step 301, an LMF receives a first request message from a first terminal or a second request message from an access and mobility management function AMF, where the first request message or the second request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function;
in step 302, in a case that the LMF receives the first request message from the first terminal, the LMF determines whether the first terminal has the authority of the first-type terminal based on the first request message; or
in step 303, in a case that the LMF receives the second request message from the AMF, the LMF uses the first terminal as the first-type terminal, and saves first information of the first terminal.

Optionally, the step that the LMF determines whether the first terminal has the authority of the first-type terminal based on the first request message includes the following steps:
the LMF acquires a user identifier of the first terminal from the AMF;
the LMF acquires subscription information of the first terminal based on the user identifier; and
the LMF determines whether the first terminal has the authority of the first-type terminal based on the subscription information of the first terminal.

Optionally, the step that the LMF determines whether the first terminal has the authority of the first-type terminal based on the first request message includes the following steps:
the LMF acquires a user identifier of the first terminal from the AMF;
the LMF determines whether pre-configured first-type terminals include the first terminal based on the user identifier; and
in a case that the pre-configured first-type terminal includes the first terminal, it is determined that the first terminal has the authority of the first-type terminal.

Optionally, the first request message or the second request message includes at least one of:
location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the first request message is a location service LCS message or a long term evolution positioning protocol LPP message.

Optionally, the method further includes the following step:
in a case that the LMF receives the first request message from the first terminal, the LMF sends a first response message to the first terminal.

Optionally, the first response message includes a key.

Optionally, the key is a private key of an asymmetric key.

Optionally, the key is used for generating a signature by the first terminal.

Optionally, the method further includes the following step:
in a case that the LMF receives the second request message from the AMF, the LMF sends a second response message to the AMF.

Optionally, the second request message includes at least one of: an identifier ID of the first terminal, location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the second response message includes a key.

Optionally, the key is a private key of an asymmetric key.

Optionally, the key is used for generating a signature by the first terminal.

Optionally, the method further includes the following step:
in a case that it is determined that the first terminal has the authority of the first-type terminal, the LMF uses the first terminal as the first-type terminal, and saves first information of the first terminal.

Optionally, the first information of the first terminal includes at least one of:
location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the step that the LMF sends a first request message from a first terminal includes the following step:
the LMF receives the first request message from the first terminal sent by the AMF, where the first request message is carried through a container in NAS signaling;
the step that the AMF sends a first response message to the first terminal includes the following step:
the LMF sends the first response message to the first terminal through the AMF, where the first response message is carried through a container in NAS signaling.

The implementation process and technical effects of the method in this embodiment are similar to those in the method embodiment on the first terminal side. For details, please refer to the detailed introduction in the method embodiment on the first terminal side, which will not be repeated here.

FIG. 12 is a fourth schematic flowchart of a terminal authentication method according to an embodiment of this application. Referring to FIG. 12, the method provided in this embodiment includes the following steps:
in step 401, a second terminal receives a first message from a first terminal, where the first message includes first information and a signature of the first terminal, and the first information is used for determining that the first terminal is a first-type terminal; the first-type terminal includes an anchor UE or a location server UE, the anchor UE is a terminal whose location is known and which participates in sending or measuring a sidelink positioning reference signal, and the location server UE is a terminal which provides a sidelink positioning service function; and
in step 402, the second terminal determines whether the first terminal has the authority of the first-type terminal based on the first message.

Optionally, the signature is generated by the first terminal based on the first information of the first terminal and a key from a target network device.

Optionally, the signature is generated by the first terminal based on the first information of the first terminal and a pre-configured key.

Optionally, the key is a private key of an asymmetric key.

Optionally, the step that the second terminal determines whether the first terminal has the authority of the first-type terminal based on the first message includes the following step:
the second terminal verifies the signature based on a public key of the asymmetric key and the first information, and determines whether the first terminal has the authority of the first-type terminal based on a verification result.

Optionally, the step that the second terminal receives a first message from the first terminal includes the following step:
the second terminal receives the first message sent by the first terminal through a sidelink unicast connection between the first terminal and the second terminal; or,
the second terminal receives the first message broadcasted and sent by the first terminal; or,
after the second terminal broadcasts a discovery solicitation message, the second terminal receives the first message, corresponding to the discovery solicitation message, sent by the first terminal and, where the first message is a discovery response message.

Optionally, the first information includes at least one of: an identifier ID of the first terminal, location information of the first terminal, a sidelink SL identifier ID of the first terminal, an indicator of having the capacity of the first-type terminal, an SL positioning capacity of the first terminal, or transport configuration information of the SL positioning reference signal PRS.

The implementation process and technical effects of the method in this embodiment are similar to those in the method embodiment on the first terminal side. For details, please refer to the detailed introduction in the method embodiment on the first terminal side, which will not be repeated here.

The terminal authentication method provided in this embodiment of this application may be executed by a terminal authentication apparatus. By taking the terminal authentication apparatus executing the terminal authentication method as an example in this embodiment of this application, the terminal authentication apparatus provided in this embodiment of this application will be described.

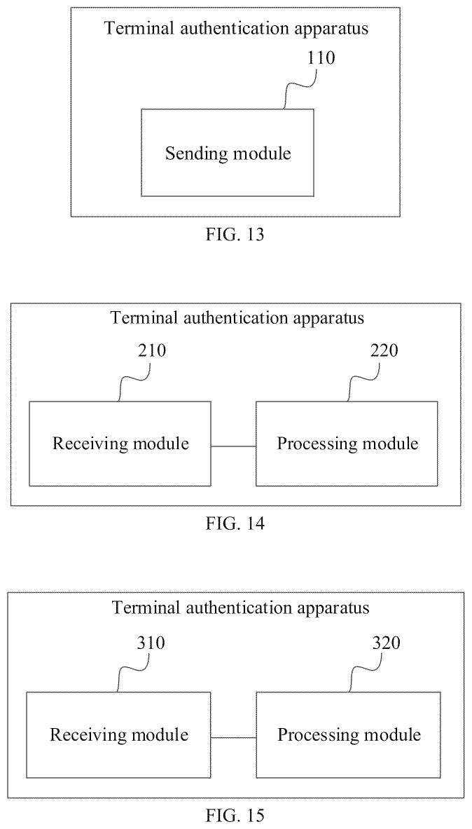

FIG. 13 is a first schematic structural diagram of a terminal authentication apparatus according to this application. Referring to FIG. 13, the terminal authentication apparatus provided in this embodiment includes:
a sending module 110 configured to send a first request message to a target network device, where the first request message is used for requesting the target network device to register a first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function.

Optionally, the apparatus further includes:
a receiving module configured to receive a first response message sent by the target network device, where the first response message is a response message corresponding to the first request message.

Optionally, the target network device is an access and mobility management function AMF, the first request message is a non-access stratum NAS message, or the target network device is a location management function LMF, and the first request message is a location service LCS message or a long term evolution positioning protocol LPP message.

Optionally, in a case that the target network device is the LMF, the sending module 110 is configured to:
send the first request message to the target network device through the AMF, where the first request message is carried through a container in NAS signaling.

Optionally, the sending module 110 is configured to:
send an uplink NAS transport message of the NAS to the AMF, where the uplink NAS transport message includes a container, and the container corresponds to the first request message.

Optionally, in a case that the target network device is the AMF, the first request message is an NAS registration request message.

Optionally, the first request message includes at least one of:
location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the first response message includes a key.

Optionally, the key is a private key of an asymmetric key.

Optionally, the apparatus further includes:
a processing module configured to generate a signature based on the key and first information of the first terminal;
the sending module 110 is further configured to send a first message to a second terminal, where the first message includes the first information and the signature, and the first information is used for determining that the first terminal is the first-type terminal.

Optionally, the sending module 110 is configured to:
send the first message to the second terminal through a sidelink unicast connection between the first terminal and the second terminal; or,
broadcast and send the first message; or
send the first message to the second terminal after receiving a discovery solicitation message broadcasted by the second terminal, where the first message is a discovery response message.

The apparatus in this embodiment may be used for executing the method according to any embodiment of the method embodiments on the first terminal side, and the implementation process and technical effects are similar to those in the method embodiment on the first terminal side. For details, please refer to the detailed introduction in the method embodiment on the first terminal side, which will not be repeated here.

FIG. 14 is a second schematic structural diagram of a terminal authentication apparatus according to this application. Referring to FIG. 14, the terminal authentication apparatus provided in this embodiment includes:
a receiving module 210 configured to receive a first request message from a first terminal, where the first request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; and
a processing module 220 configured to determine whether the first terminal has the authority of the first-type terminal based on the first request message.

Optionally, the processing module 220 is configured to:
acquire subscription information of the first terminal; and
determine whether the first terminal has the authority of the first-type terminal based on the subscription information of the first terminal and information of the first terminal included in the first request message.

Optionally, the first request message includes at least one of:
location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the first request message is a non-access stratum NAS registration request message.

Optionally, the apparatus further includes:
a sending module configured to send a first response message to the first terminal.

Optionally, the first response message includes a key.

Optionally, the key is a private key of an asymmetric key.

Optionally, the key is used for generating a signature by the first terminal.

Optionally, the sending module is further configured to:
in a case that it is determined that the first terminal has the authority of the first-type terminal, send a second request message to a location management function LMF, where the second request message is used for requesting to register the first terminal as a first-type terminal;
the receiving module 210 is configured to receive the second response message from the LMF.

The registration requested by the second request message does not require authentication by the LMF, and only the relevant information needs to be saved.

Optionally, the second request message includes at least one of: an identifier ID of the first terminal, location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the second response message includes a key.

Optionally, the key is a private key of an asymmetric key.

Optionally, the key is used for generating a signature by the first terminal.

The apparatus in this embodiment may be used for executing the method according

to any embodiment of the method embodiments on the network side, and the implementation process and technical effects are similar to those in the method embodiment on the network side. For details, please refer to the detailed introduction in the method embodiment on the network side, which will not be repeated here.

FIG. 15 is a third schematic structural diagram of a terminal authentication apparatus according to this application. Referring to FIG. 15, the terminal authentication apparatus provided in this embodiment includes:
a receiving module 310 configured to receive a first request message from a first terminal or a second request message from an access and mobility management function AMF, where the first request message or the second request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; and
a processing module 320 configured to, in a case that the first request message from the first terminal is received, determine whether the first terminal has the authority of the first-type terminal based on the first request message; or
in a case that the second request message from the AMF is received, regard the first terminal as the first-type terminal, and save first information of the first terminal.

Optionally, the processing module 320 is configured to:
acquire a user identifier of the first terminal from the AMF;
acquire subscription information of the first terminal based on the user identifier; and
determine whether the first terminal has the authority of the first-type terminal based on the subscription information of the first terminal.

Optionally, the processing module 320 is configured to:
acquire a user identifier of the first terminal from the AMF;
determine whether pre-configured first-type terminals include the first terminal based on the user identifier; and
in a case that the pre-configured first-type terminal includes the first terminal, it is determined that the first terminal has the authority of the first-type terminal.

Optionally, the first request message or the second request message includes at least one of:
location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the first request message is a location service LCS message or a long term evolution positioning protocol LPP message.

Optionally, the apparatus further includes:
a sending module configured to, in a case that the first request message from the first terminal is received, send a first response message to the first terminal.

Optionally, the first response message includes a key.

Optionally, the key is a private key of an asymmetric key.

Optionally, the key is used for generating a signature by the first terminal.

Optionally, the sending module is further configured to:
in a case that the second request message from the AMF is received, send a second response message to the AMF.

Optionally, the second request message includes at least one of: an identifier ID of the first terminal, location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the second response message includes a key.

Optionally, the key is a private key of an asymmetric key.

Optionally, the key is used for generating a signature by the first terminal.

Optionally, the processing module 320 is further configured to:
in a case that it is determined that the first terminal has the authority of the first-type terminal, regard, the first terminal as the first-type terminal, and save first information of the first terminal.

Optionally, the first information of the first terminal includes at least one of:
location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the receiving module 310 is configured to:
receive the first request message from the first terminal sent by the AMF, where the first request message is carried through a container in NAS signaling;
the sending module is configured to:
send the first response message to the first terminal through the AMF, where the first response message is carried through a container in NAS signaling.

The apparatus in this embodiment may be used for executing the method according to any embodiment of the method embodiments on the network side, and the implementation process and technical effects are similar to those in the method embodiment on the network side. For details, please refer to the detailed introduction in the method embodiment on the network side, which will not be repeated here.

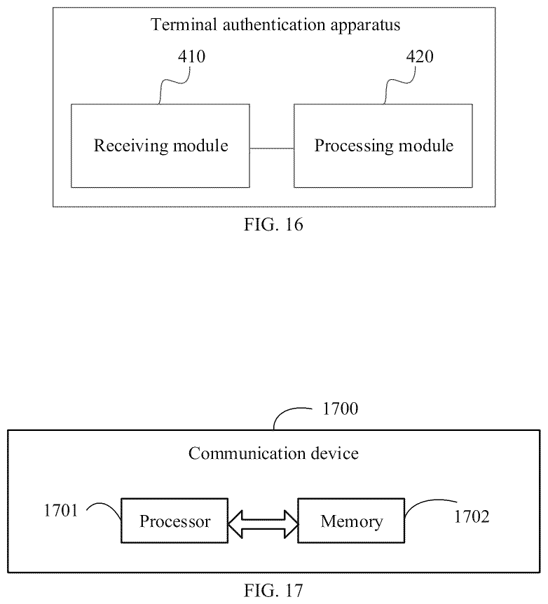

FIG. 16 is a fourth schematic structural diagram of a terminal authentication apparatus according to this application. Referring to FIG. 16, the terminal authentication apparatus provided in this embodiment includes:
a receiving module 410 configured to receive a first message from a first terminal, where the first message includes first information and a signature of the first terminal, and the first information is used for determining that the first terminal is a first-type terminal; the first-type terminal includes an anchor UE or a location server UE, the anchor UE is a terminal whose location is known and which participates in sending or measuring a sidelink positioning reference signal, and the location server UE is a terminal which provides a sidelink positioning service function; and
a processing module 420 configured to determine whether the first terminal has the authority of the first-type terminal based on the first message.

Optionally, the signature is generated by the first terminal based on the first information of the first terminal and a key from a target network device.

Optionally, the signature is generated by the first terminal based on the first information of the first terminal and a pre-configured key.

Optionally, the key is a private key of an asymmetric key.

Optionally, the processing module 420 is configured to:
verify the signature based on a public key of the asymmetric key and the first information, and determine whether the first terminal has the authority of the first-type terminal based on a verification result.

Optionally, the receiving module 410 is configured to:
receive the first message sent by the first terminal through a sidelink unicast connection between the first terminal and the second terminal; or,
receive the first message broadcasted and sent by the first terminal; or,
after the second terminal broadcasts a discovery solicitation message, receive the first message, corresponding to the discovery solicitation message, sent by the first terminal, where the first message is a discovery response message.

Optionally, the first information includes at least one of: an identifier ID of the first terminal, location information of the first terminal, a sidelink SL identifier ID of the first terminal, an indicator of having the capacity of the first-type terminal, an SL positioning capacity of the first terminal, or transport configuration information of the SL positioning reference signal PRS.

The apparatus in this embodiment may be used for executing the method according to any embodiment of the method embodiments on the second terminal side, and the implementation process and technical effects are similar to those in the method embodiment on the second terminal side. For details, please refer to the detailed introduction in the method embodiment on the second terminal side, which will not be repeated here.

In this embodiment of this application, the terminal authentication apparatus may be an electronic device, such as an electronic device with an operating system, or a component within an electronic device, such as an integrated circuit or chip. The electronic device may be a terminal or any other device except a terminal. Exemplarily, the terminal may include but is not limited to the type of the terminal 11 listed above, and the other device may be a server, a network attached storage (NAS) device or the like, which is not limited in this embodiment of this application.

The terminal authentication apparatus provided in this embodiment of this application can implement the various processes implemented in the method embodiments in FIG. 4 to FIG. 12 and achieve the same technical effects, which will not be repeated here in order to avoid repetition.

Optionally, referring to FIG. 17, an embodiment of this application further provides a communication device 1700, which includes a processor 1701 and a memory 1702. A program or instruction executable on the processor 1701 is stored on the memory 1702. For example, in a case that the communication device 1700 is a terminal, when the program or instruction is executed by the processor 1701, the various steps of the embodiment of the terminal authentication method are implemented, and the same technical effects can be achieved. In a case that the communication device 1700 is a network-side device, when the program or instruction is executed by the processor 1701, the various steps of the embodiment of the terminal authentication method are implemented, and the same technical effects can be achieved, which will not be repeated here in order to avoid repetition.

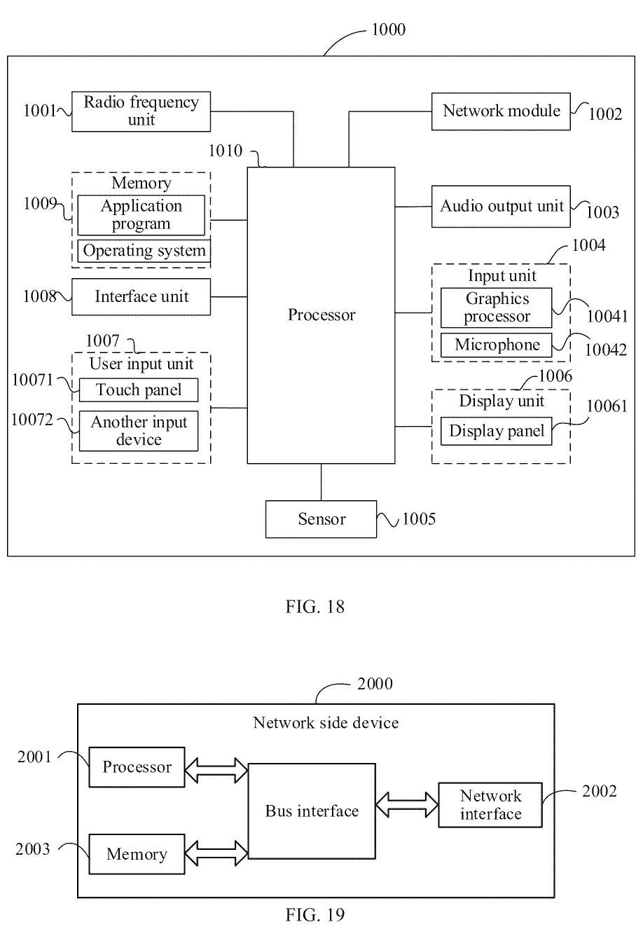

An embodiment of this application further provides a first terminal, including a processor and a communication interface, where the communication interface is configured to send a first request message to a target network device, the first request message is used for requesting the target network device to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function. This terminal embodiment corresponds to the above terminal-side method embodiment. The various implementation processes and modes in the above method embodiment are applicable to this terminal embodiment, and can achieve the same technical effect. Optionally, FIG. 18 is a schematic diagram of a hardware structure of a terminal according to an embodiment of this application.

The terminal 1000 includes, but not limited to, at least part of a radio frequency unit 1001, a network module 1002, an audio output unit 1003, an input unit 1004, a sensor 1005, a display unit 1006, a user input unit 1007, an interface unit 1008, a memory 1009, a processor 1010, etc.

It can be understood by those skilled in the art that the terminal 1000 may further include a power supply (such as a battery) for supplying power to the components. The power supply may be logically connected to the processor 1010 by a power supply management system, thus implementing functions such as charging, discharging, and power consumption management by using the power supply management system. The terminal structure illustrated in FIG. 18 constitutes no limitation on the terminal, and he terminal may include more or fewer components than those illustrated therein, or some components may be combined, or a different component deployment may be used, which will not be repeated here.

It is to be understood that in the embodiments of this application, the input unit 1004 may include a graphics processing unit (GPU) 10041 and a microphone 10042. The graphics processing unit 10041 performs processing on image data of a static picture or a video that is obtained by an image acquisition device (for example, a camera) in a video acquisition mode or an image acquisition mode. The display unit 1006 may include a display panel 10061. The display panel 10061 may be configured in the form of liquid crystal display, organic light emitting diode, or the like. The user input unit 1007 includes at least one of a touch panel 10071 or another input device 10072. The touch panel 10071 is also known as touch screen. The touch panel 10071 may include two parts, namely a touch detection apparatus and a touch controller. The other input device 10072 may include, but not limited to, a physical keyboard, a functional key (such as a volume control key or a switch key), a track ball, a mouse, and a joystick, which will not be repeated here.

In this embodiment of this application, the radio frequency unit 1001 receives downlink data from the network-side device and then may transmit it to the processor 1010 for processing; in addition, the radio frequency unit 1001 may send uplink data to the network-side device. Generally, the radio frequency unit 1001 includes, but not limited to, an antenna, at least one amplifier, a transceiver, a coupler, a low noise amplifier, a duplexer, or the like.

The memory 1009 may be configured to store a software program or instruction and various data. The memory 1009 may mainly include a first storage area and a second storage area for storing a program or instruction, where the first program or instruction storage area may store an operating system, an application program or instruction required by at least one function (for example, a sound playback function or an image display function), and the like. In addition, the memory 1009 may be a volatile memory or a non-volatile memory, or the memory 1009 may include both a volatile memory and a non-volatile memory. It may include a high-speed random access memory or a non-volatile memory, where the non-volatile memory may be a read-only memory (ROM), a programmable ROM (PROM), an erasable PROM (EPROM), an electrically EPROM (EEPROM), or a flash memory. The volatile memory may be a random access memory (RAM), a static RAM (SRAM), a dynamic RAM (DRAM), a synchronous DRAM (SDRAM), a double data rate SDRAM (DDRSDRAM), an enhanced SDRAM (ESDRAM), a synchronous link DRAM (SLDRAM), or a direct rambus RAM (DRRAM). The memory 1009 in this embodiments of this application includes, but not limited to, these and any other suitable types of memories, such as at least one disk storage device, flash memory device, or other non-volatile solid-state storage device.

The processor 1010 may include one or more processing units. Optionally, the processor 1010 may integrate an application processor and a modulation and demodulation processor, where the application processor mainly processes operations involving operating systems, user interfaces, and application programs or instructions; the modulation and demodulation processor mainly processes wireless communication signals. For example, it is a baseband processor. It is to be understood that the foregoing modem processor may not be integrated into the processor 1010.

The radio frequency unit 1001 is configured to send a first request message to a target network device, where the first request message is used for requesting the target network device to register a first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function.

Optionally, the radio frequency unit 1001 is further configured to:
receive a first response message sent by the target network device, where the first response message is a response message corresponding to the first request message.

Optionally, the target network device is an access and mobility management function AMF, the first request message is a non-access stratum NAS message, or the target network device is a location management function LMF, and the first request message is a location service LCS message or a long term evolution positioning protocol LPP message.

Optionally, in a case that the target network device is the LMF, the radio frequency unit 1001 is configured to:
send the first request message to the target network device through the AMF, where the first request message is carried through a container in NAS signaling.

Optionally, the radio frequency unit 1001 is configured to:
send an uplink NAS transport message of the NAS to the AMF, where the uplink NAS transport message includes a container, and the container corresponds to the first request message.

Optionally, in a case that the target network device is the AMF, the first request message is an NAS registration request message.

Optionally, the first request message includes at least one of:
location information of the first terminal, a sidelink SL identifier ID of the first terminal, an indicator of having the capacity of the first-type terminal, an SL positioning capacity of the first terminal, or transport configuration information of the SL positioning reference signal PRS.

Optionally, the first response message includes a key.

Optionally, the key is a private key of an asymmetric key.

Optionally, a processor 1010 is configured to generate a signature based on the key and first information of the first terminal;
the radio frequency unit 1001 is further configured to send a first message to a second terminal, where the first message includes the first information and the signature, and the first information is used for determining that the first terminal is the first-type terminal.

Optionally, the radio frequency unit 1001 is configured to:
send the first message to the second terminal through a sidelink unicast connection between the first terminal and the second terminal; or,
broadcast and send the first message; or
send the first message to the second terminal after receiving a discovery solicitation message broadcasted by the second terminal, where the first message is a discovery response message.

An embodiment of this application further provides a network-side device, including a processor and a communication interface, where the communication interface is configured to receive a first request message from a first terminal, the first request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; the processor is configured to determine whether the first terminal has the authority of the first-type terminal based on the first request message. This network-side device embodiment corresponds to the above network-side device method embodiment. The various implementation processes and modes in the above method embodiment are applicable to this network-side device embodiment, and can achieve the same technical effects.

An embodiment of this application further provides a network-side device, including a processor and a communication interface, where the communication interface is configured to receive a first request message from a first terminal or a second request message from an access and mobility management function AMF, the first request message or the second request message is used for requesting to register the first terminal as a first-type terminal, the first-type terminal includes an anchor UE or a location server UE, the anchor UE is a terminal whose location is known and which participates in sending or measuring a sidelink positioning reference signal, and the location server UE is a terminal which provides a sidelink positioning service function; the processor is configured to, in a case that the first request message from the first terminal is received, determine whether the first terminal has the authority of the first-type terminal based on the first request message; or in a case that the second request message from the AMF is received, regard the first terminal as the first-type terminal, and save first information of the first terminal. This network-side device embodiment corresponds to the above network-side device method embodiment. The various implementation processes and modes in the above method embodiment are applicable to this network-side device embodiment, and can achieve the same technical effects.

Optionally, an embodiment of this application further provides a network-side device. Referring to FIG. 19, the network-side device 2000 includes a processor 2001, a network interface 2002, and a memory 2003. The network interface 2002 may be, for example, a common public radio interface (CPRI).

Optionally, the network-side device 2000 according to this embodiment of this application further includes an instruction or program stored in the memory 2003 and executable on the processor 2001. The processor 2001 calls the instruction or program in the memory 2003 to execute the method executed by each module shown in FIG. 14 or FIG. 15, and can achieve the same technical effects, which will not be repeated here to avoid repetition.

An embodiment of this application further provides a non-transitory readable storage medium. A program or instruction is stored on the non-transitory readable storage medium. When the program or instruction is executed by a processor, the various processes of the terminal authentication method embodiment are implemented, and the same technical effects can be achieved, which will not be repeated here in order to avoid repetition.

The processor is a processor in the terminal in the above embodiment. The non-transitory readable storage medium may include a non-transitory computer-readable storage medium, such as a Read-Only Memory (ROM), a Random Access Memory (RAM), a magnetic disk, an optical disc, or the like.

An embodiment of this application further provides a chip. The chip includes a processor and a communication interface coupled to the processor. The processor is configured to run a program or instruction to implement the various processes of the terminal authentication method embodiment, and can achieve the same technical effects, which will not be repeated here in order to avoid repetition.

It is to be understood that the chip provided in this embodiment of this application may also be referred to as system level chip, system chip, chip system, or system on chip.

An embodiment of this application further provides a computer program/program product. The computer program/program product is stored on a non-transitory storage medium. The computer program/program product, when executed by at least one processor, implements the various processes of the terminal authentication method embodiment, and can achieve the same technical effects, which will not be repeated here in order to avoid repetition.

An embodiment of this application provides a communication system, including a first terminal, a second terminal, and a network-side device, where the first terminal may be configured to implement the steps of the terminal authentication method according described above, the second terminal may be configured to implement the steps of the terminal authentication method described above, and the network-side device may be configured to implement the steps of the terminal authentication method described above.

The terms “include”, “comprise” or any other variation thereof are intended to cover non-exclusive inclusion, so that a process, method, item or device that includes a series of elements not only includes those elements, but also other elements that are not explicitly listed, or also include elements inherent in such a process, method, item or device. Without further limitations, the element limited by the statement ‘including a . . . ’ does not preclude the presence of another identical element in a process, method, object or apparatus that includes that element. In addition, the scope of the methods and apparatuses in the embodiments of this application is not limited to performing functions in the order shown or discussed, but may also include performing functions in a substantially simultaneous manner or in the opposite order according to the involved functions. For example, the described methods may be executed in a different order from the described ones, and various steps may also be added, omitted or combined. In addition, features described with reference to certain examples may be combined in other examples.

Through the description of the above embodiments, those skilled in the art can clearly understand that the above embodiments may be implemented through software and necessary universal hardware platforms. Certainly, they may also be implemented through hardware. Based on this understanding, the technical solution of this application, or the part that contributes to the related technology, may be reflected in the form of a software product, which is stored in a storage medium (such as ROM/RAM, magnetic disc or optical disc), including several instructions to enable a terminal (which may be a mobile phone, a computer, a server, an air conditioner or a network device) to execute the methods described in the embodiments of this application.

The embodiments of this application have been described above with reference to the drawings. However, this application is not limited to the embodiments above. The embodiments above are only exemplary rather than restrictive. Under the inspiration of this application, those skilled in the art may make many variations without departing from the essence and the scope of protection of this application, which, however, still fall within the scope of protection of this application.

What is claimed is:

1. A terminal authentication method, comprising:
sending, by a first terminal, a first request message to a target network device, wherein the first request message is used for requesting the target network device to register the first terminal as a first-type terminal, the first-type terminal comprises an anchor user equipment (UE) or a location server UE, the anchor UE is a terminal whose location is known and which participates in sending or measuring a sidelink positioning reference signal, and the location server UE is a terminal which provides a sidelink positioning service function.

2. The terminal authentication method according to claim 1, wherein the method further comprises:
receiving, by the first terminal, a first response message sent by the target network device, wherein the first response message is a response message corresponding to the first request message.

3. The terminal authentication method according to claim 1, wherein the target network device is an access and mobility management function (AMF), and the first request message is a non-access stratum (NAS) message.

4. The terminal authentication method according to claim 3, wherein
the first request message is an NAS registration request message.

5. The terminal authentication method according to claim 1, wherein
the first request message comprises
an indicator of having capacity of the first-type terminal.

6. The terminal authentication method according to claim 5, wherein
the first request message further comprises at least one of:
location information of the first terminal, a sidelink (SL) identifier (ID) of the first terminal, an SL positioning capacity of the first terminal, or transport configuration information of the SL positioning reference signal (PRS).

7. The terminal authentication method according to claim 2, wherein the first response message comprises a key.

8. A terminal authentication method, comprising:
receiving, by an access and mobility management function (AMF), a first request message from a first terminal, wherein the first request message is used for requesting to register the first terminal as a first-type terminal, the first-type terminal comprises an anchor UE or a location server user equipment (UE), the anchor UE is a terminal whose location is known and which participates in sending or measuring a sidelink positioning reference signal, and the location server UE is a terminal which provides a sidelink positioning service function; and
determining, by the AMF, whether the first terminal has authority of the first-type terminal based on the first request message.

9. The terminal authentication method according to claim 8, wherein the determining, by the AMF, whether the first terminal has the authority of the first-type terminal based on the first request message comprises:
acquiring, by the AMF, subscription information of the first terminal; and
determining, by the AMF, whether the first terminal has the authority of the first-type terminal based on the subscription information of the first terminal and information of the first terminal comprised in the first request message.

10. The terminal authentication method according to claim 8, wherein
the first request message comprises
an indicator of having capacity of the first-type terminal.

11. The terminal authentication method according to claim 8, wherein
the first request message is a non-access stratum (NAS) registration request message.

12. A terminal, comprising a processor and a memory, wherein the memory stores a program or an instruction executable on the processor, and the program or the instruction, when executed by the processor, causes the terminal to perform:
sending a first request message to a target network device, wherein the first request message is used for requesting the target network device to register the first terminal as a first-type terminal, the first-type terminal comprises an anchor user equipment (UE) or a location server UE, the anchor UE is a terminal whose location is known and which participates in sending or measuring a sidelink positioning reference signal, and the location server UE is a terminal which provides a sidelink positioning service function.

13. The terminal according to claim 12, wherein the program or the instruction, when executed by the processor, causes the terminal to further perform:
receiving a first response message sent by the target network device, wherein the first response message is a response message corresponding to the first request message.

14. The terminal according to claim 12, wherein the target network device is an access and mobility management function (AMF), and the first request message is a non-access stratum (NAS) message.

15. The terminal according to claim 14, wherein the first request message is an NAS registration request message.

16. The terminal according to claim 12, wherein the first request message comprises an indicator of having capacity of the first-type terminal.

17. The terminal according to claim 16, wherein the first request message further comprises at least one of:
location information of the first terminal, a sidelink (SL) identifier (ID) of the first terminal, an SL positioning capacity of the first terminal, or transport configuration information of the SL positioning reference signal (PRS).

18. The terminal according to claim 13, wherein the first response message comprises a key.

19. A network-side device, comprising a processor and a memory, wherein the memory stores a program or an instruction executable on the processor, and when the program or the instruction is executed by the processor, the steps of the terminal authentication method according to claim 8 are implemented.

20. A network-side device, comprising a processor and a memory, wherein the memory stores a program or an instruction executable on the processor, and when the program or the instruction is executed by the processor, the steps of the terminal authentication method according to claim 9 are implemented.
